(19) United States
(12) Patent Application Publication
(10) Pub. No.: US 2024/0344836 A1
(43) Pub. Date: Oct. 17, 2024

(54) VEHICLE REVERSE-TRAVEL TRAJECTORY PLANNING

(71) Applicant: Ford Global Technologies, LLC, Dearborn, MI (US)

(72) Inventors: Brendan Francis Diamond, Grosse Pointe, MI (US); Michael Alan McNees, Flat Rock, MI (US); Victor Martinez, Novi, MI (US); David Michael Russell, Ann Arbor, MI (US); Jordan Barrett, Milford, MI (US); Keith Weston, Canton, MI (US)

(73) Assignee: Ford Global Technologies, LLC, Dearborn, MI (US)

(21) Appl. No.: 18/299,762

(22) Filed: Apr. 13, 2023

(51) Int. Cl. G01C 21/34; B62D 15/02; G01C 21/00

(52) U.S. Cl. CPC G01C 21/3461; B62D 15/029; G01C 21/3822

(57) ABSTRACT

A computer includes a processor and a memory, and the memory stores instructions executable by the processor to receive sensor data indicating an environment around a vehicle while the vehicle is traveling forward along a driving surface; generate a map of the environment from the sensor data, the map including at least one elevation drop; and generate a planned trajectory for the vehicle to travel in reverse and avoid the at least one elevation drop based on the map.

### BACKGROUND

Advanced driver assistance systems (ADAS) are electronic technologies that assist drivers in driving and parking functions. Examples of ADAS include forward collision warning, lane-departure warning, blind-spot warning, automatic emergency braking, adaptive cruise control, and lane-keeping assistance systems.

### BRIEF DESCRIPTION OF THE DRAWINGS

FIG. 1 is a block diagram of an example vehicle.

FIG. 2 is a diagram of the vehicle in an example environment.

FIG. 3 is a diagram of an example display of the vehicle.

FIG. 4 is a flowchart of an example process for generating data of the environment while the vehicle travels forward through the environment.

FIG. 5 is a flowchart of an example process for controlling the vehicle while traveling in reverse through the environment.

### DETAILED DESCRIPTION

This disclosure describes techniques for planning a trajectory for a vehicle to follow while traveling in reverse, i.e., backing up. A computer of the vehicle receives sensor data indicating an environment around the vehicle while the vehicle is traveling forward along a driving surface; generates a map of the environment from the sensor data, the map including at least one elevation drop; and generates a planned trajectory for the vehicle to travel in reverse and avoid the at least one elevation drop based on the map. The computer uses data gathered from the sensors while traveling forward before traveling in reverse along the planned trajectory, rather than relying solely on data from the sensors generated while the vehicle is traveling in reverse. The computer may thus gather data indicating the elevation drop from forward-facing sensors in addition to rear-facing sensors. This may permit earlier detection of an elevation drop and may increase a likelihood of detection of an elevation drop compared to relying solely on data from the sensors generated while the vehicle is traveling in reverse. While these benefits may be realized for obstacles in addition to elevation drops, the benefits may be more pronounced for elevation drops. The computer may actuate the vehicle to follow the planned trajectory or may output instructions for the operator to operate the vehicle to follow the planned trajectory.

A computer includes a processor and a memory, and the memory stores instructions executable by the processor to receive sensor data indicating an environment around a vehicle while the vehicle is traveling forward along a driving surface; generate a map of the environment from the sensor data, the map including at least one elevation drop; and generate a planned trajectory for the vehicle to travel in reverse and avoid the at least one elevation drop based on the map.

In an example, the instructions may further include instructions to record control inputs that actuate the vehicle while the vehicle is traveling forward along the driving surface, and generate the planned trajectory based on the recorded control inputs. In a further example, the instructions may further include instructions to determine reversed control inputs defining the planned trajectory based on the recorded control inputs. In a yet further example, the instructions may further include instructions to actuate the vehicle according to the reversed control inputs to follow the planned trajectory.

In another yet further example, the instructions may further include instructions to display the reversed control inputs to an operator of the vehicle.

In another yet further example, the recorded control inputs may include recorded steering inputs in a temporal order, and the reversed control inputs may include the recorded steering inputs in a reverse of the temporal order. In a still yet further example, the recorded control inputs may include recorded speeds of the vehicle in a temporal order, and the reversed control inputs may include the recorded speeds in a reverse of the temporal order.

In another further example, the instructions may further include instructions to, in response to the vehicle crossing the at least one elevation drop while the vehicle is traveling forward along the driving surface, discard the recorded control inputs.

In an example, the at least one elevation drop may have a slope above a threshold angle measured from horizontal.

In an example, the instructions may further include instructions to determine that a projected trajectory of the vehicle traveling in reverse along the driving surface intersects the at least one elevation drop, and upon determining that the projected trajectory intersects the at least one elevation drop, actuate the vehicle to avoid the at least one elevation drop. In a further example, the instructions to actuate the vehicle to avoid the at least one elevation drop may include instructions to actuate a brake system. In a yet further example, the instructions may further include instructions to, upon the vehicle stopping from actuating the brake system to avoid the at least one elevation drop, output an instruction for the vehicle to travel forward.

In another yet further example, the instructions may further include instructions to, upon the vehicle stopping from actuating the brake system to avoid the at least one elevation drop, determine that a second planned trajectory is unavailable for the vehicle traveling in reverse to avoid the at least one elevation drop, and upon determining that the second planned trajectory is unavailable, output an instruction for the vehicle to travel forward.

In another further example, the instructions to actuate the vehicle to avoid the at least one elevation drop may include instructions to actuate a steering system.

In an example, the instructions may further include instructions to display an image to an operator of the vehicle, the image highlighting the planned trajectory and the at least one elevation drop. In a further example, the image may include a camera image of the environment behind the vehicle and superimposed indications of the planned trajectory and the at least one elevation drop.

In an example, the instructions may further include instructions to determine planned control inputs for actuating the vehicle to follow the planned trajectory, and display the planned control inputs to an operator of the vehicle. In a further example, the instructions may further include instructions to display actual control inputs being provided by the operator to the vehicle alongside the planned control inputs. In a yet further example, the planned control inputs may include a planned steering-wheel angle, and the actual control inputs include an actual steering-wheel angle.

A method includes receiving sensor data indicating an environment around a vehicle while the vehicle is traveling forward along a driving surface, generating a map of the environment from the sensor data, the map including at least one elevation drop, and generating a planned trajectory for the vehicle to travel in reverse and avoid the at least one elevation drop based on the map.

With reference to the Figures, wherein like numerals indicate like parts throughout the several views, a computer 105 includes a processor and a memory, and the memory stores instructions executable by the processor to receive sensor data indicating an environment 200 around a vehicle 100 while the vehicle 100 is traveling forward along a driving surface 205; generate a map of the environment 200 from the sensor data, the map including at least one elevation drop 210; and generate a planned trajectory for the vehicle 100 to travel in reverse and avoid the at least one elevation drop 210 based on the map.

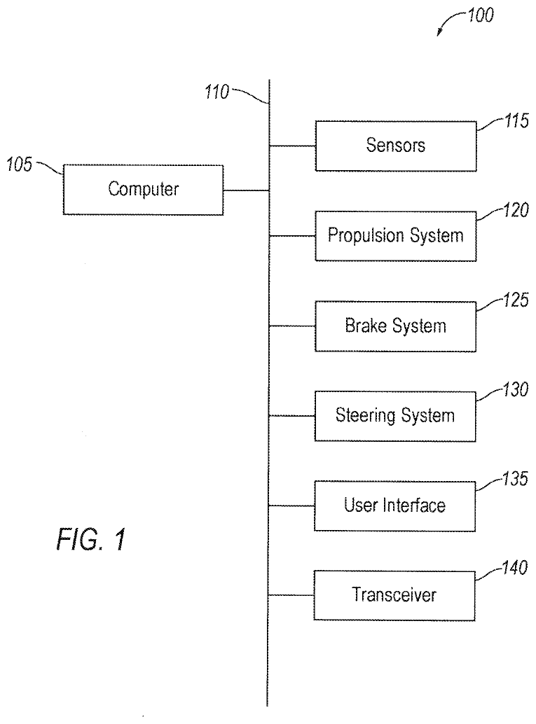

With reference to FIG. 1, the vehicle 100 may be any passenger or commercial automobile such as a car, a truck, a sport utility vehicle, a crossover, a van, a minivan, a taxi, a bus, etc.

The computer 105 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through a communications network 110 such as a controller area network (CAN) bus, Ethernet, WiFi, Local Interconnect Network (LIN), onboard diagnostics connector (OBD-II), and/or by any other wired or wireless communications network. The computer 105 may be communicatively coupled to sensors 115, a propulsion system 120, a brake system 125, a steering system 130, a user interface 135, a transceiver 140, and other components via the communications network 110.

The sensors 115 may provide data about operation of the vehicle 100, for example, wheel speed, wheel orientation, and engine and transmission data (e.g., temperature, fuel consumption, etc.). The sensors 115 may detect the location and/or orientation of the vehicle 100. For example, the sensors 115 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 115 may detect the external world, e.g., objects and/or characteristics of surroundings of the vehicle 100, such as other vehicles, road lane markings, traffic lights and/or signs, pedestrians, etc. For example, the sensors 115 may include radar sensors, ultrasonic sensors, scanning laser range finders, light detection and ranging (lidar) devices, and image processing sensors such as cameras.

The propulsion system 120 of the vehicle 100 generates energy and translates the energy into motion of the vehicle 100. The propulsion system 120 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion system 120 can include an electronic control unit (ECU) or the like that is in communication with and receives input from the computer 105 and/or a human operator. The human operator may control the propulsion system 120 via, e.g., an accelerator pedal and/or a gear-shift lever.

The brake system 125 is typically a conventional vehicle braking subsystem and resists the motion of the vehicle 100 to thereby slow and/or stop the vehicle 100. The brake system 125 may include friction brakes such as disc brakes, drum brakes, band brakes, etc.; regenerative brakes; any other suitable type of brakes; or a combination. The brake system 125 can include an electronic control unit (ECU) or the like that is in communication with and receives input from the computer 105 and/or a human operator. The human operator may control the brake system 125 via, e.g., a brake pedal.

The steering system 130 is typically a conventional vehicle steering subsystem and controls the turning of the wheels. The steering system 130 may be a rack-and-pinion system with electric power-assisted steering, a steer-by-wire system, as both are known, or any other suitable system. The steering system 130 can include an electronic control unit (ECU) or the like that is in communication with and receives input from the computer 105 and/or a human operator. The human operator may control the steering system 130 via, e.g., a steering wheel.

The user interface 135 presents information to and receives information from an operator of the vehicle 100. The user interface 135 may be located, e.g., on an instrument panel in a passenger cabin of the vehicle 100, or wherever may be readily seen by the operator. The user interface 135 may include dials, digital readouts, at least one display screen 300, speakers, and so on for providing information to the operator, e.g., human-machine interface (HMI) elements such as are known. The user interface 135 may include buttons, knobs, keypads, microphone, and so on for receiving information from the operator.

The transceiver 140 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 140 may be adapted to communicate with a remote server, that is, a server distinct and spaced from the vehicle 100. The remote server may be located outside the vehicle 100. For example, the remote server may be associated with another vehicle (e.g., V2V communications), an infrastructure component (e.g., V2I communications), an emergency responder, a mobile device associated with the owner of the vehicle 100, etc. The transceiver 140 may be one device or may include a separate transmitter and receiver.

The computer 105 is programmed to operate the vehicle 100 according to one or more control inputs. For the purposes of this disclosure, a “control input” is defined as one or more values that control operation of a component of a vehicle. For example, the components of the vehicle 100 may include the propulsion system 120 and the brake system 125, and the control input may include an input acceleration or input speed of the vehicle 100. Actuating the propulsion system 120 may include, when the input acceleration is positive or the input speed is above a current speed, setting the throttle to the input acceleration or engaging the propulsion system 120 until the current speed equals the input speed. Actuating the brake system 125 may include, when the input acceleration is negative or the input speed is below a current speed, engaging the brake system 125 with a brake force resulting in a negative acceleration equal to the input acceleration or engaging the brake system 125 until the current speed drops to the input speed. For another example, the component may include the steering system 130, and the control input may include an input steering angle. Actuating the steering system 130 according to the control input of the input steering angle may include turning the wheels until the wheels are oriented at the input steering angle.

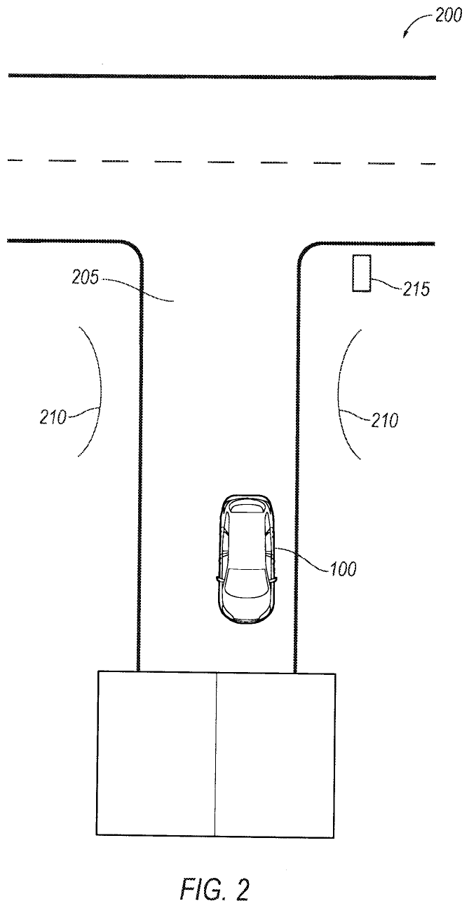

With reference to FIG. 2, the vehicle 100 is operating in the environment 200, i.e., the physical world around the vehicle 100. The environment 200 includes the driving surface 205. The driving surface 205 is a ground covering intended for vehicles to drive on, e.g., pavement, gravel, etc. The driving surface 205 is a location over which vehicles are likely to travel in both forward and reverse, such as a driveway as shown. The environment 200 may include one or more of the elevations drops and/or one or more obstacles 215. The elevation drops 210 are areas of the environment 200 at which the ground is lower than the driving surface 205 or slopes downward from a height of the driving surface 205, and navigating the vehicle 100 over the elevation drop 210 would be imprudent. The obstacles 215 are objects in the environment 200 around which the vehicle 100 should navigate.

The techniques described below pertain to a situation in which the vehicle 100 travels forward to a location on the driving surface 205 and then travels in reverse away from the location. After traveling forward to the location, the operator may turn off the vehicle 100 and leave the vehicle 100 parked for a period of time. The vehicle 100 may then travel in reverse on a subsequent trip. Alternatively, the vehicle 100 may move forward to the location, shift from forward into reverse, and travel in reverse away from the location during the same trip.

The computer 105 is programmed to receive sensor data from the sensors 115 indicating the environment 200 around the vehicle 100 while the vehicle 100 is traveling forward along the driving surface 205, as well as while the vehicle 100 is traveling in reverse on the driving surface 205. The sensor data may include point clouds from radar and/or lidar, image data from cameras, etc. The point clouds indicate a contour of the ground of the environment 200 as well as any objects in the environment.

The computer 105 may be programmed to identify any elevation drops 210 in the environment 200 based on the sensor data. The computer 105 may identify a location as an elevation drop 210 in response to the contour of the ground satisfying one or more criteria. For example, the criteria may include that a slope of the ground is above a threshold angle measured from horizontal, i.e., the slope is steeper than the threshold angle. The slope and the threshold angle may be represented in units of angles, e.g., degrees or radians, or as a unitless slope that is a ratio of rise (in units of distance) over run (in units of distance). The threshold angle may be chosen to indicate a slope that, if the vehicle 100 travels over it, would make further navigation by the vehicle 100 difficult, e.g., 45°. The slope may be determined by a vertical difference between two points of the point cloud (i.e., “rise”) over a horizontal distance between the two points (i.e., “run”). Alternatively or additionally, the criteria may include that a change in elevation is greater than a threshold height. The threshold height may be chosen to indicate terrain that, if the vehicle 100 travels over it, would make further navigation by the vehicle 100 difficult. These two criteria may be combined, e.g., the computer 105 identifies a location as an elevation drop 210 in response to both criteria being satisfied but not in response to only one criterion being satisfied. Using both criteria may prevent hills from being identified as elevation drops 210 and may prevent short curbs that are intended to be driven over as elevation drops 210.

The computer 105 may be programmed to identify the obstacles 215 in the environment 200 based on the sensor data. The computer 105 may use any suitable algorithm for grouping points in a point cloud into objects, as are known.

The computer 105 is programmed to generate a map of the environment 200 from the sensor data. The map includes any elevation drops 210 or obstacles 215 identified. For example, the computer 105 may add the locations of the elevation drops 210 and obstacles 215 to preexisting map data. The preexisting map data may be stored in the memory of the computer 105 or received via the transceiver 140. An absolute location of an elevation drop 210 or obstacle 215 may be determined by adding a relative location of the elevation drop 210 or obstacle 215 relative to the vehicle 100, known from the sensor data, to an absolute location of the vehicle 100, which may be known from, e.g., data from a GPS sensor of the sensors 115. The preexisting map data may include boundaries for the driving surface 205.

The computer 105 is programmed to record the control inputs that actuate the vehicle 100 while the vehicle 100 is traveling forward along the driving surface 205. The control inputs are stored as “recorded control inputs” in the memory of the computer 105. The recorded control inputs may include recorded steering inputs, e.g., recorded steering angles, recorded speeds, recorded accelerations, etc. The recorded control inputs are recorded in a temporal order, i.e., placed in an order in which the control inputs were received. For example, the recorded control inputs may be stored as time-series data. The recorded control inputs define a forward trajectory that the vehicle 100 follows while traveling forward over the driving surface 205.

The computer 105 may be programmed to determine whether the vehicle 100 crosses any of the elevation drops 210 or obstacles 215 and, in response to the vehicle 100 crossing at least one elevation drop 210 or obstacle 215, discard the recorded control inputs. The computer 105 may determine a footprint of the vehicle 100 on the map from a heading of the vehicle 100 and a location of the vehicle 100, e.g., from the GPS sensor. The computer 105 may determine that the vehicle 100 crosses an elevation drop 210 or obstacle 215 if the location of the elevation drop 210 or obstacle 215 on the map is inside the footprint of the vehicle 100 on the map at any point in time. The computer 105 may discard the recorded control inputs by deleting the recorded control inputs from the memory of the computer 105 or by setting a flag in memory indicating not to use the recorded control inputs.

The steps in the following paragraphs may be performed for the vehicle 100 travel in reverse over the driving surface 205. The computer 105 may be programmed to perform the steps in response to the vehicle 100 starting or the vehicle 100 being put into reverse after recording the recorded control inputs, e.g., on a subsequent trip after recording the recorded control inputs. The computer 105 may be programmed to perform the steps in response to the vehicle 100 starting and the vehicle 100 being at a preset location. The preset location may be a location from which the vehicle 100 is expected to travel in reverse, e.g., an end of a driveway. The computer 105 may receive the preset location as an input from the operator. The computer 105 may be programmed to perform the steps in response to receiving an input from the operator via the user interface 135 instructing the computer 105 to perform the steps.

The computer 105 is programmed to generate a planned trajectory for the vehicle 100 to travel in reverse and avoid the elevation drops 210 and obstacles 215. The computer 105 generates the planned trajectory based on the map and/or on the recorded control inputs. As described above, the map includes the locations of the elevation drops 210 and obstacles 215. For example, the computer 105 may use any suitable local-path-planning algorithm, as is known. The local-path-planning algorithm may be constrained to generate the planned trajectory avoid the elevation drops 210 and obstacles 215, i.e., navigate around the elevation drops 210 and obstacles 215 so as not to intersect the elevation drops 210 and obstacles 215. The local-path-planning algorithm may be permitted to generate the planned trajectory to leave the driving surface 205, while still avoiding the elevation drops 210 and obstacles 215, e.g., if needed to avoid the elevation drops 210 and obstacles 215. For another example, the planned trajectory may follow, in reverse, the forward trajectory that the vehicle 100 traveled forward on the driving surface 205 on the previous trip by the vehicle 100. The forward trajectory may be defined by the recorded control inputs. The planned trajectory may thus be generated based on the recorded control inputs.

The computer 105 is programmed to determine planned control inputs for actuating the vehicle 100 to follow the planned trajectory. For example, the computer 105 may use a motion model of the vehicle 100, as is known. The motion model is a set of equations that translates between a path that the vehicle 100 will follow and the control inputs of the vehicle 100. For another example, the computer 105 may determine reversed control inputs defining the planned trajectory based on the recorded control inputs, and use the reversed control inputs as the planned control inputs. The reversed control inputs may include the recorded control inputs, e.g., recorded steering inputs and recorded speeds, in a reverse of the temporal order of the recorded control inputs, along with the vehicle 100 being in a reverse mode instead of a forward mode. The reversed control inputs thus define the planned trajectory to follow the forward trajectory in reverse. The computer 105 refrains from using the reversed control inputs as the planned control inputs in response to the recorded control inputs being discarded, e.g., not being available from memory or a flag being set in memory indicating that the recorded control inputs have been discarded. Because the recorded control inputs are discarded if the vehicle 100 intersects an elevation drop 210 or obstacle 215, the reversed control inputs define the planned trajectory to avoid the elevation drops 210 and obstacles 215.

In one example, the computer 105 may be programmed to actuate the vehicle 100 according to the planned control inputs to follow the planned trajectory. For example, the computer 105 may actuate the propulsion system 120, the brake system 125, and/or the steering system 130 according to the planned control inputs in the order specified by the planned control inputs. The computer 105 may be programmed to actuate the vehicle 100 according to the planned control inputs in response to an input from an operator via the user interface 135 instructing the computer 105 to do so. The computer 105 may actuate the vehicle 100 according to the control inputs until the vehicle 100 reaches an end of the planned trajectory. The computer 105 may hand over operation of the vehicle 100 to the operator at the end of the planned trajectory or may switch to a different algorithm for autonomous or semi-autonomous operation of the vehicle 100. For example, the computer 105 may brake the vehicle 100 to a stop and initiate a handover to the operator in response to a location of the vehicle 100 (e.g., as indicated by GPS data) being within a threshold distance of a road (e.g., as indicated by map data). The threshold distance may be chosen such that the vehicle 100 is close to entering the road, e.g., three feet.

The computer 105 may brake the vehicle 100 to a stop and cease actuating the vehicle 100 according to the planned control inputs to follow the planned trajectory in response to an input by the operator. For example, the input may be provided through the user interface 135, or the input may be pressing the brake pedal. For another example, the operator may hold a button while the vehicle 100 follows the planned trajectory, and the input may be releasing the button. In other words, if the operator stops pressing the button while the vehicle 100 follows the planned trajectory, the computer 105 brakes the vehicle 100 to a stop and ceases actuating the vehicle 100 according to the planned control inputs.

The computer 105 may execute other autonomous or semi-autonomous features of the vehicle 100 while the computer 105 actuates the vehicle 100 according to the planned control inputs to follow the planned trajectory. For example, the computer 105 may execute one or more advanced driver assistance systems (ADAS), which are electronic technologies that assist drivers in driving and parking functions. As one example, the computer 105 may execute automatic braking to actuate the brake system 125 to stop the vehicle 100 in response to detecting an object or a previously undetected obstacle 215 within a threshold distance of the vehicle 100 based on data from the sensors 115, e.g., from rear-facing radar sensors.

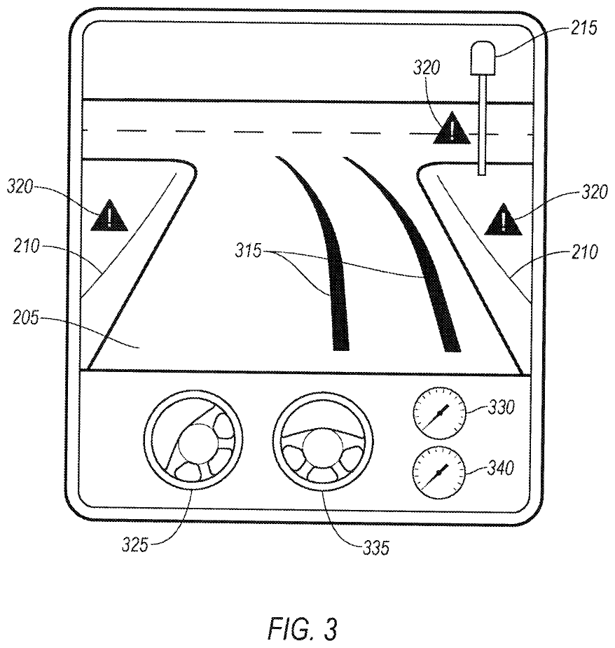

Alternatively, in another example, the computer 105 may be programmed to display the planned control inputs to an operator of the vehicle 100, e.g., via the user interface 135, as will be described in more detail below with respect to FIG. 3, while the operator operates the vehicle 100, i.e., controls the propulsion system 120, brake system 125, and steering system 130. (The computer 105 may display the planned control inputs to the operator even if the computer 105 is actuating the vehicle 100 according to the planned control inputs.)

The computer 105 may be programmed to determine a projected trajectory based on received control inputs. For example, the operator may provide control inputs that deviate from the planned control inputs, in which case the projected trajectory will deviate from the planned trajectory. The computer 105 may determine the projected trajectory based on the received control inputs by using the motion model of the vehicle 100. As the vehicle 100 travels in reverse over the driving surface 205 and possibly deviates from the planned trajectory, the computer 105 may update the planned trajectory by re-generating the planned trajectory in the manner described above.

The computer 105 may be programmed to determine that a projected trajectory of the vehicle 100 traveling in reverse along the driving surface 205 intersects an elevation drop 210 or obstacle 215. For example, the computer 105 may determine that the location of an elevation drop 210 or obstacle 215 in the map is less than a preset distance from the projected trajectory. The preset distance may be chosen based on dimensions of the vehicle 100 to encompass a swept path of the vehicle 100 traveling along the trajectory and will be slightly greater than half a width of the vehicle 100. For another example, the computer 105 may identify an elevation drop 210 or obstacle 215, as described above, from sensor data received while the vehicle 100 is traveling in reverse. The computer 105 may determine the location of the elevation drop 210 or obstacle 215 as described above and then determine that the location is within the preset distance from the projected trajectory.

The computer 105 may be programmed to, in response to determining that the projected trajectory intersects an elevation drop 210 or obstacle 215, actuate the vehicle 100 to avoid the elevation drop 210 or obstacle 215. The computer 105 may actuate the vehicle 100 to avoid the elevation drop 210 or obstacle 215 by actuating the brake system 125 and/or the steering system 130. For example, the computer 105 may actuate the brake system 125 to attempt to stop the vehicle 100 before intersecting the elevation drop 210 or obstacle 215, e.g., according to an automated emergency braking algorithm, as is known, and as may be used by the vehicle 100 during forward travel. For another example, the computer 105 may actuate the brake system 125 to attempt to turn the vehicle 100 before intersecting the elevation drop 210 or obstacle 215, e.g., according to an evasive steering assistance algorithm, as is known, and as may be used by the vehicle 100 during forward travel.

The computer 105 may actuate the vehicle 100 to avoid the elevation drop 210 or obstacle 215 in response to determining that the projected trajectory intersects the elevation drop 210 or obstacle 215 within a preset distance from the vehicle 100 or a preset path length along the projected trajectory from the vehicle 100. The preset distance or preset path length may be chosen based on a stopping distance and/or turning radius of the vehicle 100 for avoiding the elevation drop 210 or obstacle 215.

The computer 105 may be programmed to, upon the vehicle 100 stopping from actuating the brake system 125 to avoid the elevation drop 210 or obstacle 215, determine an updated planned trajectory for the vehicle 100 traveling in reverse to avoid the elevation drop 210 or obstacle 215, in the manner described above. Upon determining the updated planned trajectory, the computer 105 may actuate the vehicle 100 to follow the updated planned trajectory or may display the planned control inputs for the updated planned trajectory, as described above. If the computer 105 is unable to determine an updated planned trajectory for the vehicle 100 traveling in reverse to avoid the elevation drop 210 or obstacle 215, e.g., if all potential planned trajectories generated by the computer 105 intersect the elevation drop 210 or obstacle 215, the computer 105 determines that an updated planned trajectory is unavailable.

The computer 105 may be programmed to, upon determining that an updated planned trajectory is unavailable, output an instruction for the vehicle 100 to travel forward. The instruction may be an instruction to actuate the vehicle 100 to travel forward, e.g., to actuate the propulsion system 120, as well possibly the brake system 125 and/or the steering system 130, to move the vehicle 100 forward, e.g., for a preset distance. The preset distance may be chosen to provide sufficient space that an updated planned trajectory is likely to be available for the vehicle 100 to travel in reverse. Alternatively, the instruction may be an output to the user interface 135 to indicate that the operator should drive the vehicle 100 forward.

With reference to FIG. 3, the computer 105 may be programmed to display an image 305 and/or other graphics to an operator of the vehicle 100, e.g., on a display screen 300 of the user interface 135. The display screen 300 conveys information usable by the operator to operate the vehicle 100 in reverse to follow the planned trajectory and avoid the elevation drops 210 and obstacles 215.

The image 305 may include a camera image 310 of the environment 200 behind the vehicle 100. For example, the sensors 115 may include a rear-facing camera, and the user interface 135 may display the camera images 310 returned by the rear-facing camera to the display screen 300 in real time, i.e., as received from the camera.

The image 305 may highlight the planned trajectory, i.e., display some graphical indication of the planned trajectory. For example, the image 305 may include a superimposed indication 315 of the planned trajectory, e.g., curved lines showing where the vehicle 100 will travel when following the planned trajectory from a perspective of the rear-facing camera generating the camera image 310. The curved lines may be determined by applying a known geometric transformation to the planned trajectory. The geometric transformation converts from three-dimensional coordinates to pixel coordinates of an image plane of the camera.

The image 305 may highlight the elevation drops 210 and obstacles 215, i.e., display some graphical indications of the elevation drops 210 and obstacles 215. For example, the image 305 may include superimposed indications 320 of the respective elevation drops 210 and obstacles 215. The superimposed indications 320 may be graphics chosen to convey that the operator should avoid the elevation drop 210 or obstacle 215. The pixel locations of the superimposed indications 320 in the image 305 may be determined by applying the known geometric transformation to the locations of the elevation drops 210 and obstacles 215 from the map.

The computer 105 may be programmed to display the planned control inputs to the operator on the display screen 300. The computer 105 may be further programmed to display actual control inputs being provided by the operator to the vehicle 100 alongside the planned control inputs. The operator may use the displayed planned control inputs and the displayed actual control inputs to operate the vehicle 100 to follow the planned trajectory, e.g., by perceiving a visual difference between the displayed planned control inputs and the displayed actual control inputs. For example, the planned control inputs may include a planned steering-wheel angle 325 and/or a planned speed 330, and the actual control inputs may include an actual steering-wheel angle 335 and/or an actual speed 340. The planned steering-wheel angle 325 and the actual steering-wheel angle 335 may be represented as graphics of steering wheels turned by the respective angles. The planned speed 330 and the actual speed 340 may be represented as speedometers with needles at the respective speeds, as shown in FIG. 3, or as numerical values of the respective speeds. Using these, the operator may be able to adjust a turning of the steering wheel and a pressure applied to the brake pedal to more closely follow the planned trajectory.

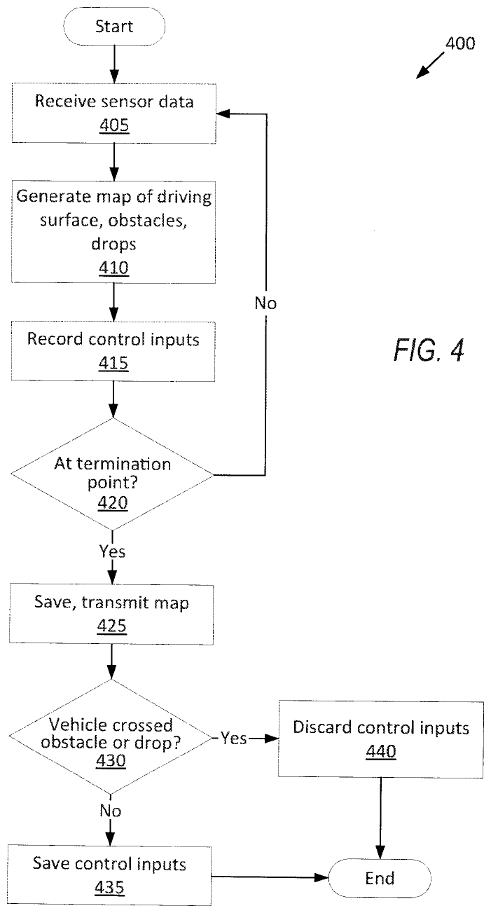

FIG. 4 is a flowchart illustrating an example process 400 for generating data of the environment 200 while the vehicle 100 travels forward through the environment 200. The memory of the computer 105 stores executable instructions for performing the steps of the process 400 and/or programming can be implemented in structures such as mentioned above. The computer 105 may execute the process 400 in response to the vehicle 100 traveling forward through an area identified as the driving surface 205, e.g., in response to an input from the operator via the user interface 135 indicating to record the control inputs. As a general overview of the process 400, the computer 105 receives sensor data from the sensors 115, generates the map of the environment 200, and records the control inputs while the vehicle 100 is traveling forward. Upon the vehicle 100 reaching a termination point of a forward trajectory, the computer 105 saves and transmits the map. The computer 105 either saves or discards the control inputs depending on whether the vehicle 100 crossed an elevation drop 210 or obstacle 215.

The process 400 begins in a block 405, in which the computer 105 receives the sensor data from the sensors 115 indicating the environment 200 around the vehicle 100 while the vehicle 100 is traveling forward along the driving surface 205, as described above.

Next, in a block 410, the computer 105 generates the map of the environment 200 from the sensor data, including any elevation drops 210 and obstacles 215, as described above. The computer 105 may iteratively generate the map by adding new elevation drops 210 and obstacles 215 as detected in the sensor data.

Next, in a block 415, the computer 105 records the control inputs that actuate the vehicle 100 while the vehicle 100 is traveling forward along the driving surface 205, as described above.

Next, in a decision block 420, the computer 105 determines whether the vehicle 100 is at a termination point of a forward trajectory of the vehicle 100. For example, the computer 105 determines whether the vehicle 100 is at a location designated as a parking spot for the vehicle 100, e.g., according to a prior input from the operator, e.g., based on a position of the vehicle 100 returned by a GPS sensor of the sensors 115. For another example, the computer 105 determines whether the operator has provided an input via the user interface 135 instructing the computer 105 to stop recording the control inputs. For another example, the computer 105 determines whether an input has been received indicating that a trip of the vehicle 100 is over, e.g., the vehicle 100 has been turned off or the vehicle 100 has been put from forward into park or reverse. If the vehicle 100 is not yet at a termination point, the process 400 returns to the block 405 to continue detecting elevation drops 210 and obstacles 215 and recording the control inputs. Upon determining that the vehicle 100 is at the termination point, the process 400 proceeds to a block 425.

In the block 425, the computer 105 saves the map as generated in the memory of the computer 105. The computer 105 may also transmit the map to a remote server via the transceiver 140.

Next, in a decision block 430, the computer 105 determines whether the vehicle 100 crossed any elevation drops 210 or obstacles 215, as described above. In response to the vehicle 100 not crossing any elevation drops 210 or obstacles 215 while the vehicle 100 is traveling forward along the driving surface 205, the process 400 proceeds to a block 435. In response to the vehicle 100 crossing at least one elevation drop 210 or obstacle 215 while the vehicle 100 is traveling forward along the driving surface 205, the process 400 proceeds to a block 440.

In the block 435, the computer 105 saves the recorded control inputs to the memory of the computer 105 so that the recorded control inputs are available for a later trip of the vehicle 100, as described above. After the block 435, the process 400 ends.

In the block 440, the computer 105 discards the recorded control inputs, as described above. After the block 440, the process 400 ends.

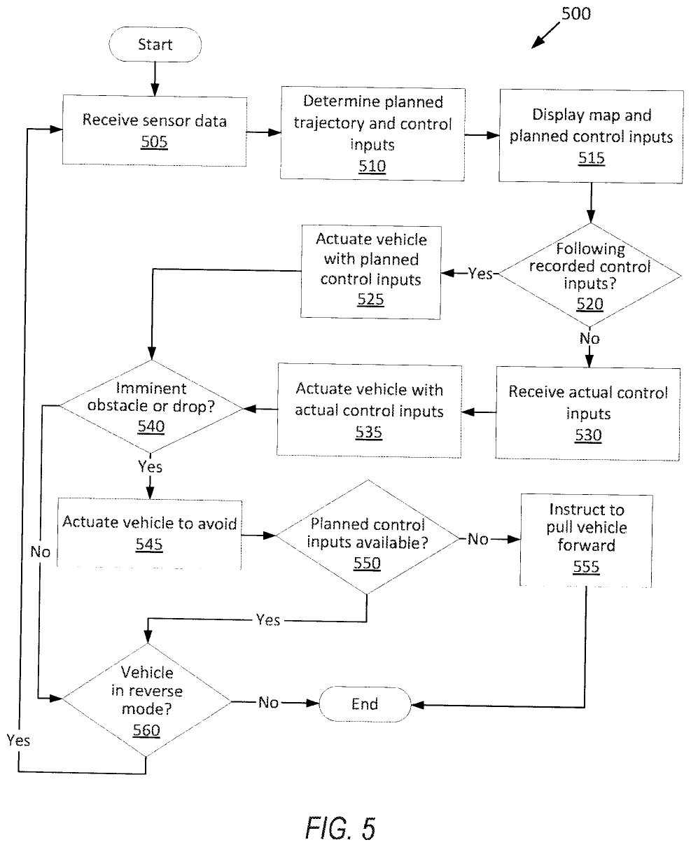

FIG. 5 is a flowchart illustrating an example process 500 for controlling the vehicle 100 while traveling in reverse through the environment 200. The memory of the computer 105 stores executable instructions for performing the steps of the process 500 and/or programming can be implemented in structures such as mentioned above. The computer 105 may be programmed to execute the process 500 in response to the vehicle 100 being put in reverse on a same trip or a next trip after saving the map or recording the recorded control inputs. As a general overview of the process 500, the computer 105 receives the sensor data from the sensors 115, determines the planned trajectory and the planned control inputs, and displays the image 305 and the planned control inputs. If the computer 105 is to actuate the vehicle 100 to follow the planned control inputs, the computer 105 does so. Otherwise, the computer 105 receives the actual control inputs from the operator and actuates the vehicle 100 according to the actual control inputs. Upon determining that the projected trajectory of the vehicle 100 intersects an elevation drop 210 or obstacle 215, the computer 105 actuates the vehicle 100 to avoid the elevation drop 210 or obstacle 215, and upon determining that an updated planned trajectory is unavailable, outputs an instruction for the vehicle 100 to travel forward. The process 500 continues for as long as the vehicle 100 is in reverse.

The process 500 begins in a block 505, in which the computer 105 receives the sensor data from the sensors 115 indicating the environment 200 around the vehicle 100, as described above. The computer 105 may receive the map including the locations of any elevation drops 210 or obstacles 215 via the transceiver 140 from a remote server, e.g., if another vehicle 100 recorded the map, or the computer 105 may already have the map in memory from traveling the forward trajectory.

Next, in a block 510, the computer 105 generates the planned trajectory for the vehicle 100 to travel in reverse and determines the planned control inputs for actuating the vehicle 100 to follow the planned trajectory, as described above.

Next, in a block 515, the computer 105 displays the image 305, the planned control inputs, and/or the actual control inputs to the operator of the vehicle 100, as described above.

Next, in a decision block 520, the computer 105 determines whether the computer 105 will actuate the vehicle 100 to follow the planned control inputs or whether the operator will provide the actual control inputs for actuating the vehicle 100. For example, the computer 105 may determine whether an input received via the user interface 135 indicates whether the computer 105 or operator will control the motion of the vehicle 100. In the absence of an input so indicating, the computer 105 may determine that the operator will control the vehicle 100. Upon determining that the computer 105 will actuate the vehicle 100, the process 500 proceeds to a block 525. Upon determining that the operator will control the motion of the vehicle 100, the process 500 proceeds to a block 530.

In the block 525, the computer 105 actuates the vehicle 100 according to the planned control inputs to follow the planned trajectory, as described above. After the block 525, the process 500 proceeds to a decision block 540.

In the block 530, the computer 105 receives the actual control inputs from the operator, e.g., via the steering wheel, accelerator pedal, and/or the brake pedal.

Next, in a block 535, the computer 105 actuates the vehicle 100, e.g., the propulsion system 120, the brake system 125, and the steering system 130, according to the actual control inputs. After the block 535, the process 500 proceeds to the decision block 540.

In the decision block 540, the computer 105 determines whether the projected trajectory of the vehicle 100 traveling in reverse along the driving surface 205 intersects an elevation drop 210 or obstacle 215. Upon determining that the projected trajectory intersects at least one elevation drop 210 or obstacle 215, the process 500 proceeds to a block 545. Otherwise, the process 500 proceeds to a decision block 560.

In the block 545, the computer 105 actuates the vehicle 100, e.g., the brake system 125 and/or the steering system 130, to avoid the elevation drop 210 or obstacle 215, as described above.

Next, in a decision block 550, the computer 105 determines whether an updated planned trajectory is available for the vehicle 100 to travel in reverse and avoid the elevation drop 210 or obstacle 215, as described above. Upon determining that an updated planned trajectory is available, the process 500 proceeds to the decision block 560. Upon determining that an updated planned trajectory is unavailable, the process 500 proceeds to a block 555.

In the block 555, the computer 105 outputs an instruction for the vehicle 100 to travel forward, as described above. After the block 555, the process 500 ends.

In the decision block 560, the computer 105 determines whether the vehicle 100 is still in reverse. Upon determining that the vehicle 100 is in reverse, the process 500 returns to the block 505 to continue redetermining and following the planned trajectory. In response to the vehicle 100 being put into forward or park or being turned off, the process 500 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. The adjectives “first” and “second” are used throughout this document as identifiers and are not intended to signify importance, order, or quantity. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
receive sensor data indicating an environment around a vehicle while the vehicle is traveling forward along a driving surface;
generate a map of the environment from the sensor data, the map including at least one elevation drop; and
generate a planned trajectory for the vehicle to travel in reverse and avoid the at least one elevation drop based on the map.

2. The computer of claim 1, wherein the instructions further include instructions to record control inputs that actuate the vehicle while the vehicle is traveling forward along the driving surface, and generate the planned trajectory based on the recorded control inputs.

3. The computer of claim 2, wherein the instructions further include instructions to determine reversed control inputs defining the planned trajectory based on the recorded control inputs.

4. The computer of claim 3, wherein the instructions further include instructions to actuate the vehicle according to the reversed control inputs to follow the planned trajectory.

5. The computer of claim 3, wherein the instructions further include instructions to display the reversed control inputs to an operator of the vehicle.

6. The computer of claim 3, wherein the recorded control inputs include recorded steering inputs in a temporal order, and the reversed control inputs include the recorded steering inputs in a reverse of the temporal order.

7. The computer of claim 6, wherein the recorded control inputs include recorded speeds of the vehicle in a temporal order, and the reversed control inputs include the recorded speeds in a reverse of the temporal order.

8. The computer of claim 2, wherein the instructions further include instructions to, in response to the vehicle crossing the at least one elevation drop while the vehicle is traveling forward along the driving surface, discard the recorded control inputs.

9. The computer of claim 1, wherein the at least one elevation drop has a slope above a threshold angle measured from horizontal.

10. The computer of claim 1, wherein the instructions further include instructions to determine that a projected trajectory of the vehicle traveling in reverse along the driving surface intersects the at least one elevation drop, and upon determining that the projected trajectory intersects the at least one elevation drop, actuate the vehicle to avoid the at least one elevation drop.

11. The computer of claim 10, wherein the instructions to actuate the vehicle to avoid the at least one elevation drop include instructions to actuate a brake system.

12. The computer of claim 11, wherein the instructions further include instructions to, upon the vehicle stopping from actuating the brake system to avoid the at least one elevation drop, output an instruction for the vehicle to travel forward.

13. The computer of claim 11, wherein the instructions further include instructions to, upon the vehicle stopping from actuating the brake system to avoid the at least one elevation drop, determine that a second planned trajectory is unavailable for the vehicle traveling in reverse to avoid the at least one elevation drop, and upon determining that the second planned trajectory is unavailable, output an instruction for the vehicle to travel forward.

14. The computer of claim 10, wherein the instructions to actuate the vehicle to avoid the at least one elevation drop include instructions to actuate a steering system.

15. The computer of claim 1, wherein the instructions further include instructions to display an image to an operator of the vehicle, the image highlighting the planned trajectory and the at least one elevation drop.

16. The computer of claim 15, wherein the image includes a camera image of the environment behind the vehicle and superimposed indications of the planned trajectory and the at least one elevation drop.

17. The computer of claim 1, wherein the instructions further include instructions to determine planned control inputs for actuating the vehicle to follow the planned trajectory, and display the planned control inputs to an operator of the vehicle.

18. The computer of claim 17, wherein the instructions further include instructions to display actual control inputs being provided by the operator to the vehicle alongside the planned control inputs.

19. The computer of claim 18, wherein the planned control inputs include a planned steering-wheel angle, and the actual control inputs include an actual steering-wheel angle.

20. A method comprising:
receiving sensor data indicating an environment around a vehicle while the vehicle is traveling forward along a driving surface;
generating a map of the environment from the sensor data, the map including at least one elevation drop; and
generating a planned trajectory for the vehicle to travel in reverse and avoid the at least one elevation drop based on the map.
